(19) United States
(12) Patent Application Publication
(10) Pub. No.: US 2024/0276373 A1
(43) Pub. Date: Aug. 15, 2024

(54) CONTINUOUS DEVICE INTERACTION DISCOVERY

(71) Applicant: APPLE INC., CUPERTINO, CA (US)

(72) Inventors: Benjamin A. Detwiler, San Diego, CA (US); Brent M. Ledvina, San Francisco, CA (US); Michele Bavaro, Cupertino, CA (US); Yujie Xu, San Diego, CA (US)

(73) Assignee: APPLE INC., CUPERTINO, CA (US)

(21) Appl. No.: 18/409,370

(22) Filed: Jan. 10, 2024

Related U.S. Application Data
(60) Provisional application No. 63/484,520, filed on Feb. 12, 2023.

(51) Int. Cl. H04W 52/02; H04W 4/80

(52) U.S. Cl. CPC H04W 52/0225; H04W 4/80

(57) ABSTRACT

The techniques disclosed herein may include receiving proximity messages during a first time period via a wireless personal area network. Each proximity message may include a proximity identifier calculated using a unique identifier for a proximate electronic device. In addition, the techniques may include retrieving, from a database, a set of device identifiers corresponding to devices in the first electronic device's contact list. The techniques may include for each message: determining whether the proximity identifier of the proximate electronic device matches a device identifier, thereby determining matching proximity messages. Moreover, the techniques may include generating an event score for the first time period based on the matching proximity messages, the event score having a probability that an event has occurred between the first electronic device another device. Also, the techniques may include determining whether an event has occurred by comparing the event score to an event threshold.

This application claims priority to U.S. Provisional Application No. 63/484,520, for “CONTINUOUS DEVICE INTERACTION DISCOVERY” filed on Feb. 12, 2023, which is herein incorporated by reference in its entirety for all purposes.

### FIELD

The present disclosure relates generally to techniques for performing device detection with electronic devices.

### BACKGROUND

Device discovery is a problem of identifying nearby electronic devices. Device discovery can involve listening for wireless short-range communication messages broadcast by nearby (e.g., proximate) electronic devices. Wireless short-range communication messages (e.g., Bluetooth Low Energy (BLE) advertisements) from other devices can be received at a device's wireless short-range communication chip and stored in the chip's buffer. But such a configuration can limit the ability to detect nearby devices for extended periods of time, particularly without using excessive battery storage. In addition, privacy conscious users can be concerned about storing a log of discovered devices. Accordingly, improvements to device discovery techniques are desirable.

### BRIEF SUMMARY

Certain embodiments are directed to techniques (e.g., a device, a method, a memory or non-transitory computer readable medium storing code or instructions executable by one or more processors) for device discovery according to the present disclosure. The techniques can include methods for detecting proximity messages from nearby devices and identifying interaction events using the messages.

In one general aspect, the techniques may include receiving, from one or more other devices, proximity messages at the wireless short-range communication chip. The techniques may also include forwarding, via a power management bus, the proximity messages to the coprocessor of the SOC, while the processor is in a low power mode. The techniques may furthermore include processing the proximity messages by the coprocessor to obtain processed proximity messages. The techniques may in addition include storing the processed proximity message in a proximity buffer in the memory (e.g., one or more memories) of the SOC. The techniques may moreover include determining whether a triggering event has occurred. The techniques may also include responsive to a triggering event, waking the processor from the low power mode. The techniques may furthermore include analyzing the processed proximity messages using the processor. Other embodiments of this aspect include corresponding computer systems, apparatus, and computer programs recorded on one or more computer storage devices, each configured to perform the actions of the methods.

In one general aspect, the techniques may include receiving a plurality of proximity messages during a first time period, the proximity messages being received via a wireless personal area network, where each proximity message may include a proximity identifier calculated using an unique identifier for a proximate electronic device that transmitted the proximity message. The techniques may also include retrieving a set of device identifiers from an identifier database, the set of device identifiers corresponding to a set of electronic devices in a contact list for the first electronic device. The techniques may furthermore include for each message in the plurality of proximity messages: determining whether the proximity identifier of the proximate electronic device matches a device identifier of the set of electronic devices, thereby determining matching proximity messages. The techniques may in addition include generating an event score for one or more portions of the first time period based on the matching proximity messages, the event score having a probability that an event has occurred between the first electronic device and one or more proximate electronic devices. The techniques may moreover include determining whether an event has occurred during the time period by comparing the event score to an event threshold. Other embodiments of this aspect include corresponding computer systems, apparatus, and computer programs recorded on one or more computer storage devices, each configured to perform the actions of the methods.

These and other embodiments of the disclosure are described in detail below. For example, other embodiments are directed to systems, devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 shows a simplified diagram of an exchange of proximity messages between electronic devices according to at least one embodiment.

FIGS. 2A-2C show simplified diagrams of various environments with electronic devices exchanging proximity messages according to at least one embodiment.

FIG. 3 is a simplified diagram of an architecture for performing device discovery according to at least one embodiment.

FIG. 4 is a simplified flowchart of a technique for processing and analyzing a proximity message according to at least one embodiment.

FIG. 5 shows a simplified diagram of a modified key exchange for anonymized device discovery according to at least one embodiment.

FIG. 6 shows a line diagram depicting event score calculations for two interaction events according to various embodiments.

FIG. 7 shows a simplified diagram of an interaction event according to at least one embodiment.

FIG. 8 shows a simplified diagram of event score calculation according to at least one embodiment.

FIG. 9 is a simplified flowchart of a technique for determining whether an interaction event has occurred according to at least one embodiment.

FIG. 10 is a block diagram of an example electronic device according to at least one embodiment.

### DETAILED DESCRIPTION OF THE INVENTION

Certain embodiments are directed to techniques (e.g., a device, a method, a memory or non-transitory computer readable medium storing code or instructions executable by one or more processors) for device discovery techniques.

Device discovery techniques with ranging between electronic devices, such as a mobile device, can allow for a first device to log interactions with other devices. This log may be an anonymized ledger of times when the first electronic device encountered another device. These devices, including the first device, can regularly broadcast short-range proximity messages (e.g., Bluetooth Low Energy (BLE) advertisement messages) and a nearby device receiving these messages can use them to determine whether an interaction between the broadcaster and receiver has occurred.

However, electronic devices are nearly ubiquitous in many environments and simply recording a list of proximate devices may not provide the receiving device's user with relevant information. For example, without filtering the proximity messages, an electronic device for an individual who commutes by subway may log interactions with hundreds or thousands of electronic devices that do not have a meaningful relationship with the individual. Accordingly, it is desirable to differentiate between meaningful interaction events with a device that has a connection to an individual and chance encounters with unrelated devices.

A matching process can be used to determine if a received proximity message is from a broadcaster with a relationship to the receiver. The matching process can use a unique identifier of the broadcaster (also referred to as the broadcasting device). The proximity message can have a proximity identifier that is generated by signing the broadcasting device's unique identifier using a private key. Thus, the proximity identifier can be generated as a digital signature.

The proximity identifier can be matched (e.g., via a decryption-like process) to a device in a contact list of the receiving device using a public key that the broadcasting device shares with related devices. For example, the public keys can be stored in a database and a receiving device can regularly retrieve the public keys for the device's contacts list from the database. As an alternative or in addition, the public key can be exchanged using techniques that do not require a database such as via a near-field communication protocol or by reading a matrix barcode.

As part of the matching process, the receiving device can determine whether proximity identifier is consistent with (matches) a device identifier stored in the contact list of the receiving device. For example, the receiving device can perform a verification process that applies part of the public key (e.g., an exponentiation value and a modulus value) to the proximity identifier to obtain a first result. Then, the receiving device can confirm the first result matches a second result generated by applying a second part of the public key to the device identifier (e.g., a modulus function). The proximity identifier may be a hash or a modulus result that is generated using the private key. Thus, the proximity identifier may not be unique (e.g., if a hash collision occurs). But the use of time (or a part of the verification process that changes over time) can reduce the likelihood that such collisions would persist, thereby allowing a unique determination that the broadcasting device is present in the contact list.

Some embodiments can only identify that a device in the contact list was present as opposed to identifying the device and exposing such information to the user of the receiving device. In this manner, the proximity identifier can protect the anonymity of a broadcasting device. Further unrelated devices can identify the broadcasting deice, e.g., because the proximity identifier can only be decrypted using the public key. In addition, the proximity identifier cannot be used to directly obtain the device identifier even with the public key. Instead, the proximity identifier can only be used to determine that the decrypted proximity identifier and the device identifier are consistent (i.e., match). As such, the device identifier cannot be determined in its entirety from just the proximity identifier, as the device identifier must be known by the verifying device. A decrypted proximity identifier may match a device identifier with a probability that is sufficient for interaction event detection while still matching a few potential device identifiers. In addition, the interaction events can be stored anonymously, and, after an event is recorded, the proximity message and the decrypted proximity message can be deleted.

Such techniques can allow a determination of an event score that corresponds to whether the user of the receiving device was part of an event (e.g., a social gathering). Such a determination can be used in various ways, e.g., as a trigger for an application, such as for journalling, a camera application, a social media application, etc.

A further problem for such device detection is that monitoring for proximity messages can be energy inefficient because the mobile device's main processor may need to analyze the messages. The proximity messages can be received at a wireless short-range communication chip (e.g., Bluetooth Low Energy (BLE) chip). To conserve power, a low power coprocessor, which is always on, can retrieve the messages from the communication chip and store them in a buffer in memory. The low power coprocessor can be part of a system on a chip (SOC) with memory and a main processor. The in-memory buffer can be flushed to the main processor on a when it wakes, or the coprocessor can wake the processor and flush the buffer when the buffer is full. After waking, the processor can handle any pending advertisements and return to sleep. Because the buffer on the system on a chip is larger than the wireless short-range communication chip's buffer, the processor can be woken less frequently, and it can process larger batches at each wake. Accordingly, an architecture with an always-on coprocessor is more energy efficient than an architecture that processes advertisements using a wireless short-range communication chip buffer.

### I. Interaction Events

Interaction events are intended to capture meaningful contact between two or more individuals with a preexisting relationship. Meaningful contact can be a meeting between electronic devices that occur in uncommon or non-routine circumstances. Interaction events can be distinguished from encounters where two individuals, with or without a preexisting relationship, happen to be near each other. Both interaction events and encounters can be detected by proximity messages exchanged between the individuals' electronic devices. Upon or after receiving a proximity message, a receiving electronic device can attempt to process the proximity message to see if there is an acceptable likelihood that the message is from a broadcasting electronic device associated with one of the broadcasting device's contacts. If the message is from a contact, the receiving electronic device can determine whether an interaction event has occurred.

Interaction events can be used for varied purposes. For instance, a journaling application can use recorded interaction events as writing prompts (e.g., “Journal detected an event from 2:00-2:45 PM”). The interaction events may be recorded with some information about the event, such as a number of devices present during the event, a start time for the event, an end time for the event, or a rough location for the event (e.g., the city but not the street address). For privacy reasons, the interaction events are anonymous and simply record that there was an interaction event, and no personal identifying data is recorded for any participants in the interaction event.

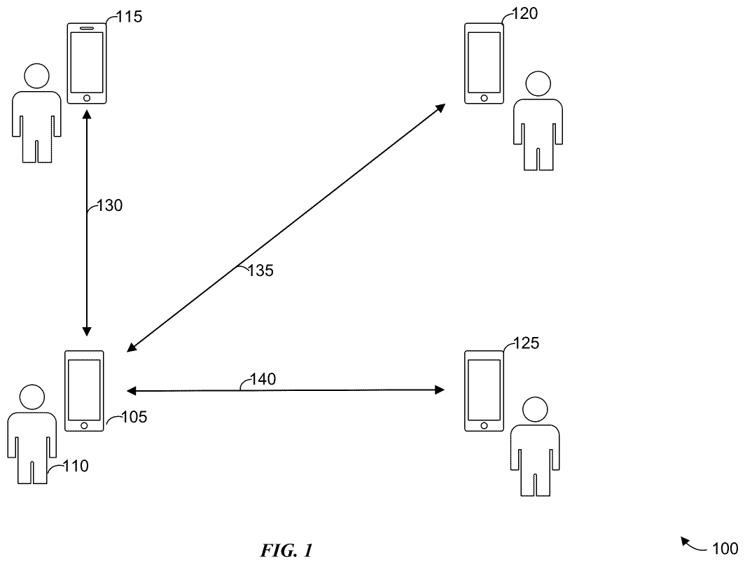

FIG. 1 shows a simplified diagram of an exchange of proximity messages between devices according to at least one embodiment. Primary electronic device 105 is an electronic device belonging to a user 110. The primary electronic device 105 has a number of entries in a contact list representing accounts that the user 110 has saved to her primary electronic device 105. Primary electronic device 105 exchanges proximity messages with electronic devices and, at the conclusion of a time period, primary electronic device 105 can attempt to process these messages to obtain processed proximity messages. The time period can be timeframe where the primary electronic device 105 collects proximity messages, and at the conclusion of the time period the primary electronic device 105 can process the proximity messages to generate processed proximity messages. Processing may include deduping or purging the messages in a buffer so that only one message per device is processed in a given time period. The primary electronic device may keep a record of which time period, and how many time periods, each

The contact list for primary electronic device 105 includes an entry for user accounts that are logged into related electronic device 115 and related electronic device 120, but the user account that is logged into unrelated electronic device 125 may be absent from the contact list. The contact list can represent user accounts that are associated with the primary electronic device 105 but other techniques for identifying accounts that are associated with the primary electronic device 105 are contemplated. For instance, a favorites list, a list of accounts that have exchanged texts or phone calls with the primary electronic device 105 or any other list of accounts can be used to identify user accounts that are associated with primary electronic device 105.

The primary electronic device 105 and related electronic device 115 are separated by a first distance 130. This distance is short enough for the exchange of proximity messages over a wireless personal area network using wireless short-range communication chips. The proximity messages can be Bluetooth messages and the wireless short-range communication chips can be Bluetooth Low Energy (BLE) chips. Related electronic device 115 can be a proximate device, with respect to primary electronic device 105, because primary electronic device 105 can receive and process messages from related electronic device 115 (e.g., related electronic device 115 is in range of primary electronic device 105 and related to primary electronic device 105).

Related electronic device 120, like related electronic device 115, is related to primary electronic device 105. However, primary electronic device 105 and related electronic device 115 are separated by a second distance that is longer than the first distance 130 and proximity messages cannot be successfully exchanged between the devices. The second distance 135 may be too long for the proximity messages to travel between devices with an intact payload, or filtering on primary electronic device 105, such as a received signal strength filer, may exclude messages above a threshold distance from the receiving device (e.g., primary electronic device 105 may exclude messages with a RSSI below a signal threshold). Accordingly, even though related electronic device 120 is related to primary electronic device 105, related electronic device 120 is not a proximate device with respect to primary electronic device 105.

Unrelated electronic device 125 is separated from the primary electronic device 105 by a third distance 140 that is approximately the same length as the first distance 130. However, unlike related electronic device 115, unrelated electronic device 125 is not related to the first electronic device. Therefore, primary electronic device 105 cannot process the proximity messages received from unrelated electronic device 125 and those messages can be disregarded by primary electronic device 105.

While the successful exchange of proximity messages is necessary for interaction event detection, the exchange may not be sufficient to detect an interaction event. For example, if two devices are near each other regularly any interaction between the devices may not be meaningful (e.g., worth recording in a journal). For example, two roommates or coworkers may successfully exchange proximity messages on a daily basis, but the interactions between the individuals operating the devices may be routine and uneventful. Conversely, a single exchange of messages can be caused by a transient encounter that the individuals carrying the devices might not notice. For example, one device may be with an individual who is ordering coffee inside of a shop while the other device may be carried by someone passing the shop. Accordingly, the proximity messages can be analyzed to determine if an interaction event has occurred.

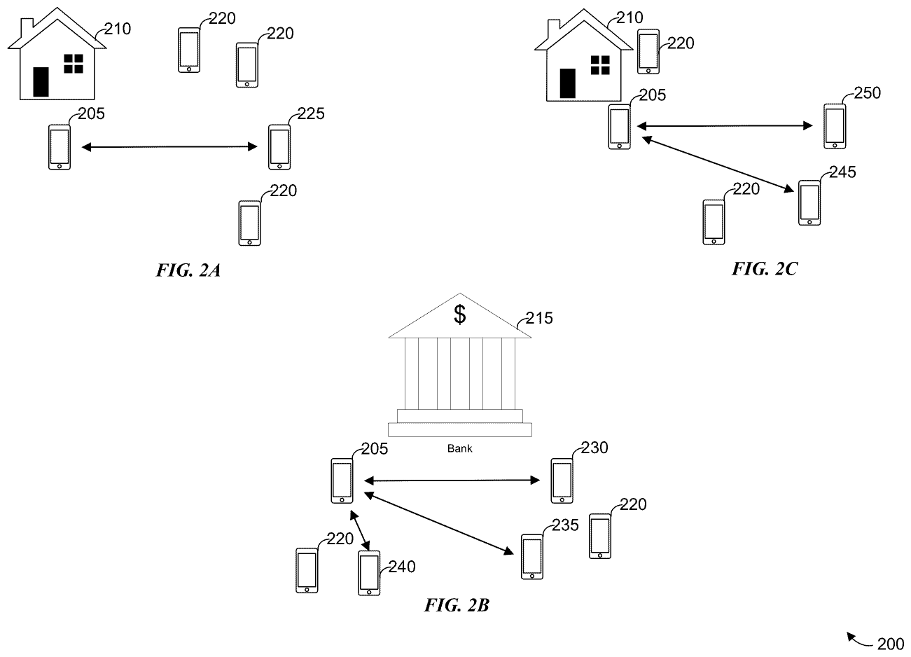

FIGS. 2A-2C show simplified diagrams of various environments with electronic devices exchanging proximity messages according to at least one embodiment. Primary electronic device 205 can be a device that an individual is carrying during their day, and, in FIG. 2A, the individual is at their home 210. Later in the day, in FIG. 2B, the individual visits the bank 215 before returning home 210 in FIG. 2C to host a party with several friends.

During the day, the primary electronic device 205 receives proximity messages from unrelated electronic devices 220. Because the primary electronic device 205 cannot process these messages to generate processed proximity messages, the primary electronic device may never identify an interaction event with the unrelated electronic devices.

Turning now to FIG. 2A, whether two devices interact regularly can determine if an interaction event has occurred. Related electronic device 225 can be controlled by the roommate of the individual operating the primary electronic device 205 (e.g., the primary individual). Accordingly, the related electronic device 225 and the primary electronic device regularly exchange proximity messages because they share a common living space. As a result, even though the primary electronic device 205 exchanges messages with the related electronic device 225 on a nearly daily basis, the primary electronic device does not detect an interaction event in FIG. 2A. An interaction event should be a meaningful interaction that an individual may wish to acknowledge, but routine interactions with a familiar individual are not likely to be considered meaningful by either party.

Turning now to FIG. 2B, the number of devices that interact simultaneously can determine if an interaction event occurs. FIG. 2B shows the primary electronic device at a bank 215. The visit to the bank depicted in FIG. 2B is relatively short and does not last longer than half an hour. While at the bank 215, the primary electronic device 205 exchanges proximity messages with related electronic devices 230, 235, 240. The primary electronic device successfully processes the proximity messages from each device. The primary electronic device determines that it encountered related electronic devices 230, 235, 240 for five minutes each. The encounters with related electronic devices 235, 240 overlap while the encounter with related electronic device 230 did not overlap with the other devices.

In this case, the primary electronic device detects an interaction event for the time period of the first proximity message received from either of related electronic devices 235, 240 to the last proximity message received from the devices. The primary electronic device 205 may detect an interaction event for the encounter with electronic devices 235, 240 because meeting multiple related devices simultaneously may be a meaningful interaction may be worth documenting even if the length of the encounter is relatively short. Conversely, the encounter with related electronic device 230 may not be recorded as an interaction event because an encounter with a single device may not be worth memorializing.

Turning now to FIG. 2C, the length of the encounter between electronic devices can determine if an interaction event has occurred. FIG. 2C shows the primary electronic device at home 210. In this case, the primary electronic device 205 is joined by a related electronic device 245 corresponding to a first friend of the primary individual. The primary individual has invited the friend to the home 210 to play a board game. During the three-hour time period while the primary individual and friend play the board game, primary electronic device 205 and the related electronic device 245 exchange proximity messages. After the game has concluded and the first friend leaves, a second friend, carrying related electronic device 250, returns a basketball and his device interacts with the primary electronic device for five minutes.

Based on these interactions, the primary electronic device 205 detects an interaction event for the first friend because there is a continuous three-hour period where devices that do not normally interact encounter each other. A prolonged interaction with a related device may be an interaction event if the interactions between these devices are infrequent. In addition, the primary electronic device does not record an interaction event for the second friend, because, even though these devices do not routinely interact, the encounter was short.

While the number of devices involved in an encounter, and the length of the encounter, may be used to determine if an interaction event has occurred, the interaction event may be stripped of these details when the interaction event is recorded in the primary electronic device 205. The interaction event may be recorded as an event without details about the number of devices in attendance. In addition, the length of the interaction event may not be documented, and, for example, the interaction event can be recorded with a start time, an end time, a midpoint, a part of the day (e.g., morning, noon, afternoon, evening, dusk, dawn, late night, early morning, breakfast, lunch, dinner, etc.). The amount of information recorded with each interaction event may be customizable with a primary individual able to configure which details are included in the event.

### II. Interaction Event Detection Architecture

Processing proximity messages can mean monitoring for received messages over a sustained period of time. This monitoring can be a drain on an electronic devices' battery. An architecture with a low power coprocessor to collect and process the proximity messages as they arrive, and a primary processor to calculate the event score for batches of processed proximity messages can be used to perform event detection in an energy efficient fashion.

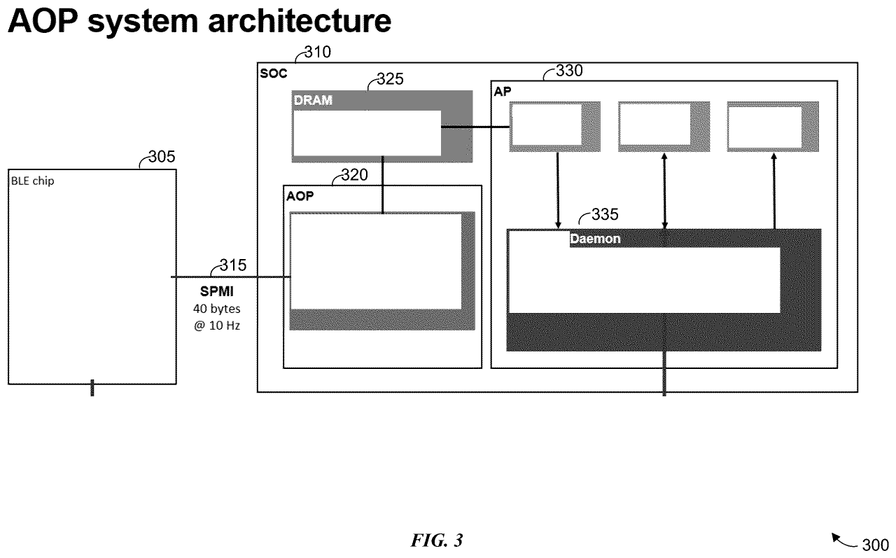

FIG. 3 is a simplified diagram of an architecture 300 for performing device discovery according to at least one embodiment. Proximity messages can be received at the primary electronic device from other electronic devices at an antenna connected to a Bluetooth Lowe Energy (BLE) chip 305. The BLE chip 305 can be circuitry for analyzing, forwarding, or storing messages received over a wireless sort-range network (e.g., a wireless short-range chip). In this case, the BLE chip is connected to a System On a Chip (SOC) 310 by a power management bus 315 that supports bidirectional communication with one or more processors. The power management bus 315 is a connection that the BLE chip 305 can use to wake a processor that is connected to the chip. SOC 310 can be a single piece of silicon that contains circuitry to implement most or all of the functionality of a computing device (e.g., processing, memory, Input/Output connections).

The Always-On-Processor (AOP) 320 can receive proximity messages from the BLE chip 305 via the power management bus 315. While the power management bus 315 can be used to wake a processor, the AOP 320 is a low power coprocessor that is functioning continuously while the electronic device is powered. The AOP 320 can process the proximity messages by deduplicating the messages, associating proximity devices from related electronic devices with their respective devices, and discarding proximity messages from unrelated devices. Deduplicating can be a process where duplicate copies of repeating data are removed to improve storage utilization. To deduplicate, AOP 320 can analyze data in memory to identify unique contiguous groups of data, called byte patterns or chunks, that occur within the analyzed data. These identified byte patterns can be stored to memory 325. During deduplication, the AOP 320 can search the memory to determine any other locations where a particular byte pattern is repeated. If the byte pattern is repeated, the AOP 320 can remove the byte pattern from memory and replace the pattern with a reference (e.g., a pointer or address) to the stored byte pattern. Because a reference can be smaller than the byte pattern, and because byte patterns can repeat tens, hundreds, or thousands of times in memory, this deduplication process can significantly reduce the amount of data stored in memory 325.

The processed proximity messages generated by the AOP 320 can be saved to memory 325 (e.g., Random Access Memory (RAM), Dynamic Random Access Memory (DRAM), etc.). At regular intervals or when the memory 325 is full, the processor 330 can collect the processed proximity messages from the memory 325 and process the messages using a daemon 335. The daemon 335 can determine a unique identifier associated with each processed message, calculate an event score, and provide the event score to other software, services or applications.

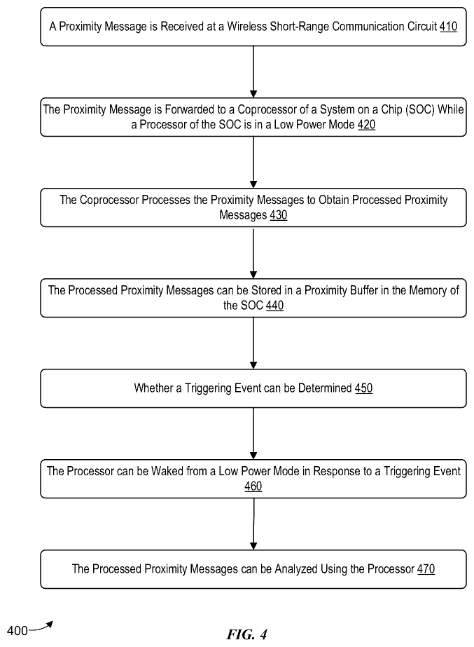

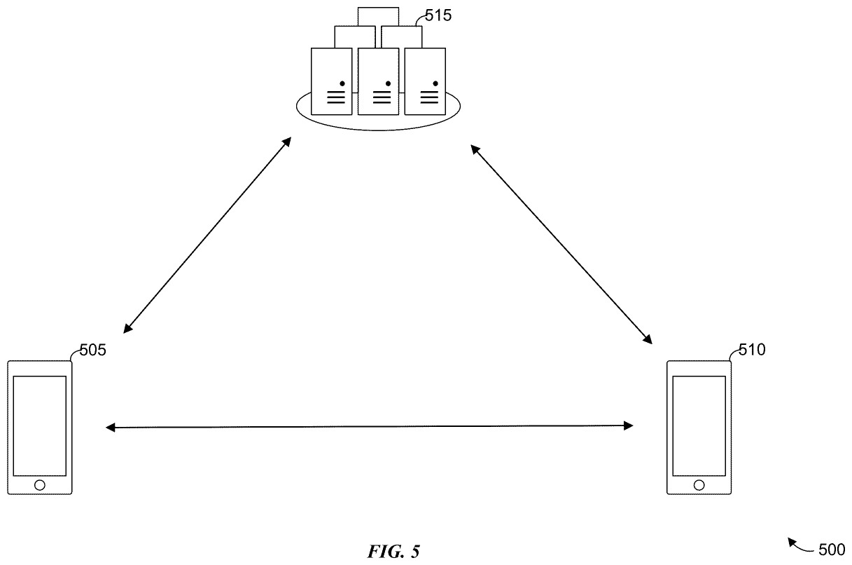

FIG. 4 is a simplified flowchart of a technique for processing and analyzing a proximity message according to at least one embodiment. In some implementations, one or more method blocks of FIG. 5 may be performed by an electronic device (e.g., primary electronic devices 105, 205, 505, electronic devices 115, 120, 220, 225, 230, 235, 240, 245, 250, architecture 300, electronic device 1000). In some implementations, one or more method blocks of FIG. 5 may be performed by another device or a group of devices separate from or including the electronic device.

Additionally, or alternatively, one or more method blocks of FIG. 5 may be performed by one or more components of an electronic device (e.g., primary electronic devices 105, 205, 505, electronic devices 115, 120, 220, 225, 230, 235, 240, 245, 250, architecture 300, electronic device 1000), such as BLE chip 305, SOC 310, AOP 520, memory 325, processor 330, wireless circuitry 1008, processor 1018, etc.

Turning to method 400 in greater detail, at block 410, proximity messages can be received at a wireless short-range communication circuit (e.g., BLE chip 305). The messages can be received at one or more devices (e.g., primary electronic devices 105, 205, 505, electronic devices 115, 120, 220, 225, 230, 235, 240, 245, 250, architecture 300, electronic device 1000).

At block 420, the proximity message can be forwarded to the coprocessor of a system on a chip (SOC). The message can be forwarded by the BLE chip 305 via the power management bus 315 to AOP 320 on SOC 310. The messages can be forwarded while processor 330 is in a low power mode.

At block 430, the coprocessor can process the proximity messages to obtain processed proximity messages. Processing the messages can include removing duplicate proximity messages (e.g., deduplicating the messages). Processing may include removing messages with a RSSI value that is below a threshold (e.g., the devices were too far from the electronic device). The RSSI value can be calculated by the BLE chip 305 when the proximity message was received. Deduplicating a proximity message can mean identifying at least one byte chunk in a proximity message forwarded in 420, storing the at least one byte chunk in memory 325, determining one or more locations in the proximity messages where each byte chunk of the at least one byte chunk is repeated in the proximity messages, and replacing the repeated one or more byte chunks with a reference to the stored byte chunks in memory.

At block 340, the proximity messages can be stored in a proximity buffer in the memory of the SOC. The memory can be the memory 325 and the SOC can be SOC 310.

At block 350, whether a triggering event has occurred can be determined. A triggering event can be the expiration of a time period, or the number of entities in the buffer reaching a threshold. The triggering event (e.g., trigger event) may be a threshold (e.g., memory threshold) based on the memory utilization (e.g., an event can be triggered when 100% of the memory is used). A triggering event can include a user interacting with the electronic device or otherwise causing the processor to wake.

At block 460, the processor can be woken from a low power mode in response to a determination at 350 that a triggering event has occurred. The AOP 320 may wake the processor 330 in response to the triggering event.

At block 470, the processed proximity messages can be analyzed using the processor. The processed proximity messages can be analyzed to determine if an interaction event has occurred. Analyzing processed proximity messages is discussed in greater detail below with regard to method 900.

### III. Anonymized Interaction Events

Individuals may have privacy concerns about interaction events. In particular, there may be concerns that a log of interactions contains personal information can be used to reconstruct someone's activities. These concerns can be mitigated by anonymized interaction events that record encounters between related electronic devices without personally identifiable information.

### A. Generating Proximity Messages

FIG. 5 shows a simplified diagram of a modified key exchange for anonymized device discovery according to at least one embodiment. This key exchange can be one way, with a dedicated broadcasting device and a dedicated receiving device, or two-way where both electronic devices both broadcast and receive proximity messages. In this example, primary electronic device 505 and related electronic device 510 both send and receive proximity messages as part of a two-way key exchange. However, the primary electronic device 505 is described as receiving a proximity message from the related electronic device 510 for illustrative purposes even though both devices may broadcast and receive proximity messages.

Primary electronic device 505 can receive a proximity message from the related electronic device 510. The proximity message can be a proximity identifier that was calculated by signing a unique identifier for the related electronic device 510 with a private key. Signing a unique identifier can mean appending a signature, or a value calculated from the unique identifier using a private key (e.g., Rivest-Shamir-Adleman public-key), to a message containing the unique identifier to produce a proximity message. It should be computationally infeasible to generate the proximity message's signature without the private key and the signature should be able to be verified using a public key associated with the private key. In some situations, the signature can be generated for the unique identifier and a timestamp so that the time the proximity message was generated can be verified. In one example, a public key-private key pair can be created by generating a key pair containing a modulus, N, that is the product of two random secret distinct large primes, along with integers, e and d, such that e d≡1 (mod ϕ(N)), where φ is Euler's totient function. In this example, the public key can consist of N and e, and the private key can contain d. Signing the message can include computing a signature, σ, such that σ≡md (mod N), where md is a modular exponentiation operation. To verify, the receiver checks that σe=m

In some embodiments, the proximity identifier can be anonymized to produce the proximity message by removing one or more bits from the string of bits that comprise the proximity identifier (e.g., remove the first bit, the second bit, the last two bits, etc). Removing bits can allow the proximity identifier to be partially anonymous, even after decryption (e.g., digital signature verification), because the unique identifier cannot be fully reconstructed from the proximity identifier. Instead, a probability that the unique identifier and the reconstructed unique identifier can be determined and this identifier, which may match other electronic devices, can be sufficient for event detection purposes.

The private key, and its corresponding public key stored in database 515, may be static or the keys may be periodically changed (e.g., every 15 minutes). For example, the keys can be updated at regular intervals or after each message so that a single public key can only be used to decrypt a small number of proximity messages. In addition, the old public keys can be deleted from the database 515 after they are updated so that the proximity messages cannot be decrypted during later time periods.

Upon or after receiving the proximity message, or at regular intervals, the primary electronic device can retrieve a list of public keys, corresponding to one or more related devices, from the database 515. The primary electronic device may be related to a device if an account associated with the related electronic device is in a contacts list on the primary electronic device. In addition or alternatively, the devices may be related if the primary electronic device 505 and the related electronic device 510 have interacted in a time period (e.g., exchanged text messages, video chatted, exchanged a phone call, interacted on an application, and the like). In some embodiments, the devices may be related if the number of interactions in a time period are above a threshold. The time period can be 5 seconds, 10 seconds, 20 seconds, 50 seconds, 1 minute, 5 minutes, 10 minutes, 15 minutes, 50 minutes, 1 hour, 2 hours, 5 hours, 12 hours, a day, a week.

The retrieved list of public keys can be used by the primary electronic device 505 to process the proximity message received from the related electronic device 510. The primary electronic device 505 may process the received proximity message as they are received or as part of a batch of messages stored in memory. For example, proximity messages may be processed by a coprocessor, stored in the memory of primary electronic device 505, and provided to the primary electronic device's processor in batches. Processing the proximity messages can involve deduplicating the proximity messages and attempting to verify the proximity messages' signatures using the list of public keys. If a proximity message can be verified, then the message was a processed proximity message from a related electronic device, if the message cannot be decrypted, the message was from an unrelated electronic device and cannot be processed.

### B. Event Scores

The processed proximity messages can be stored in a memory in the primary electronic device 505, and the device's processor can use the processed proximity messages to calculate an event score representing a probability that an interaction event has occurred. These processed proximity messages each represent a probability that a proximity message was exchanged with a related electronic device in the contacts list for the primary electronic device during the most

recent time period. The primary electronic device 505 may calculate the event scores using the event scores from a previous time period that precedes the most recent time period. For example, event scores can persist for four weeks. By using event scores from previous time periods, routine interactions with familiar related electronic devices (e.g., a roommate's device) can be distinguished from interaction events. The event score can be compared against two thresholds to determine if an interaction event has occurred. If the event score is too low (e.g., below a first threshold) there was not enough of an encounter between the devices for an interaction event. If the event score is too high (e.g., above a second threshold) then the regular contact between these two devices suggests that the encounter was routine and no interaction event occurred.

For example, the event score for the previous event score can include scores for related electronic devices (e.g., unique identifiers) that exchanged proximity messages with the primary electronic device 505 during time periods that precede the most recent time period. If, during the current time period, no proximity messages are exchanged with a particular related electronic device, with an event score from a previous time period, the event score can be decremented by a decrement value. If there is an exchange of proximity messages between these devices during the most recent time period, the event score can be incremented by an increment value. The increment value and the decrement value can have the same magnitude or different magnitudes in case it is desirable to have the event score increase or decay more rapidly.

The magnitude of the increment value can change based on the number of devices that sent the primary electronic device 505 proximity messages during the current time period. It may be more likely that an interaction event has occurred if the primary electronic device 505 is encountering multiple related devices simultaneously. For instance, the increment value for each related device that sent a proximity message to the primary electronic device 505 may be weighted based on the number of related electronic devices encountered during the time period (e.g., three devices were encountered so the increment value is tripled).

In addition, the increment score may be weighted based on the location where the exchange of proximity messages occurred. An exchange of messages at a routine location may not be weighted while an exchange of messages at a new location may be weighted by a greater amount. Further, other interactions between the devices can impact the magnitude of the weight for the increment value. For example, if the primary electronic device and the related electronic deice communicate via a cellular network (e.g., communicate through a phone call, a short messaging service (SMS) message, a videotelephony call, a text-based communication through an application, and the like), then the weight for the increment value may be increased.

The weight for the increment value may be increased based on a relationship between the primary electronic device 505 and the related electronic device 510. For example, related electronic devices with unique identifiers that are in a favorites list, are designated as family in the contacts list, or featured as emergency contacts in the primary electronic device may be weighted higher. The activities performed by the primary electronic device during the time period may be used to change the weight of the increment value. For example, if the primary electronic device is used to control the television during the time period, the primary individual may be watching television with the person controlling the related electronic device and this may be an interaction event. Conversely, the weight may be decreased if the primary electronic device is performing a solo activity such as listening to a podcast on headphones.

While the exchange of proximity messages may be symmetrical, the calculation of interaction events using the event score may not be. Potentially, one participant in an encounter may classify the event as an interaction event while the other participant may not detect an interaction event. In addition, it is possible that the related electronic device 510 is related to the primary electronic device 505 (e.g., in the contacts of the primary device) while the primary electronic device 505 is not related to the related electronic device 510.

The proximity messages may be filtered to exclude messages from devices that are above a threshold distance from the primary electronic device 505. In such circumstances, received signal strength indicator (RSSI) can be used to exclude proximity messages from devices that are far enough away that an interaction event is not likely. Received signal strength indicator (RSSI) is a measure of the power in a received signal. One or more antennas in an electronics device's array can be configured to measure the received signal strength. The received signal strength can be represented as a negative number with arbitrary units that can vary between implementations. For example, the Institute of Electrical and Electronics Engineers (IEEE) 602.11 technical standard for implementing wireless area network communication and Bluetooth Low Energy (BLE) wireless personal area technology both use decibel-milliwatts (− dBm) as the units for received signal strength, however other units are contemplated.

A signal's strength can be determined with an electronic device's wireless communication antennas. Electronic devices often contain components for wireless communication and RSSI can allow for distance measurements without specialized hardware. To measure RSSI, a primary electronic device can transmit a signal that is received by one or more related electronic devices. The signal's power attenuates at a regular rate that can be used to determine a rough distance between the devices.

The event score can be calculated at the conclusion of a time period called an event interval. For example, the time period for an event interval can be an hour that is divided into five-minute interaction intervals. At the conclusion of an interaction interval, an electronic device can request the proximity messages that were received during that interaction interval. Using the received proximity messages, the electronic device can identify proximity messages from some or all of the electronic phone's contacts (e.g., the top 64 contacts), and, for each contact, the electronic device can identify the number of interaction intervals where proximity messages from the contact were received. At the end of the event interval, the duration of the interaction for each contact (e.g., the number of interaction intervals) is summed and an event score can be calculated as described below.

The event score for a contact (e.g., contact score) can be the proportion of active interaction intervals for that contact. An active interaction interval is an interaction interval where the electronic device received at least one proximity message for that contact. This contact score can be calculated by summing the contacts active interaction intervals and normalizing the sum for an event interval by dividing the sum by the total number of interaction intervals in the event interval. The event score for an event interval can be the sum of each contact's contact score. The event score can be calculated using the following formula:

$$S = \frac{{J}_{0} + {J}_{1} + … + {J}_{n - 1}}{E} \qquad ( 1 )$$

Where S is the event score for an event interval, E is the length of the event interval (e.g., in interaction intervals; 12 for a 60 minute event interval with 5 minute interaction intervals), Jis the number of active interaction intervals for a contact, and n is the number of contacts.

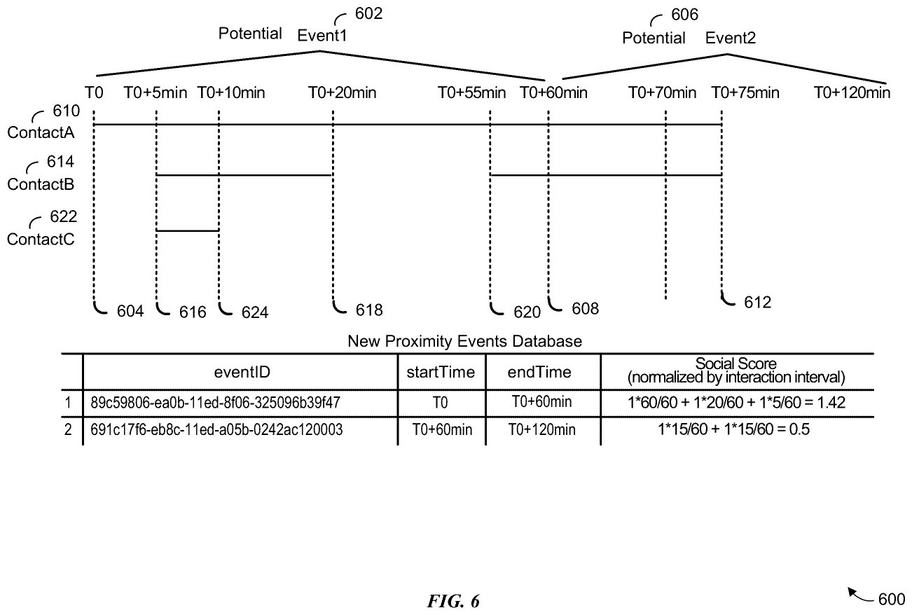

FIG. 6 shows a line diagram 600 depicting event score calculations for two interaction events according to various embodiments. As depicted in line diagram 600, an event score is calculated for contiguous 60-minute event intervals that correspond to potential events. However, the event intervals corresponding to potential events may not be contiguous in all embodiments with overlapping event intervals or event intervals that are separated by gaps in time.

As depicted in diagram 600, the event interval for potential event 1 602 begins at line 604 at t0. The event intervals for potential event 1 602 and potential event 2 606 are separated by line 608 at t0+60 minutes. Line diagram 600 shows active interaction events corresponding to time periods where an electronic device has received proximity messages from mobile devices that are in the electronic device's contact list. The electronic device has received proximity messages from contact A 610 over a series of active interaction intervals that extend from line 604 at t0 to line 612 at t0+75 minutes. Contact B 614 has two separate series of active interaction intervals: 1) from line 616 at t0+5 minutes to line 618 at t0+20 minutes; and 2) from line 620 at t0+55 minutes to line 612 at t0+75. The electronic device only received proximity messages from contact C 622 over an active interaction interval from line 616 at t0+5 minutes to line 624 at t0+10 minutes.

Proximity messages for both contact A 610 and contact B 614 are received during active interaction intervals during the event intervals that correspond to potential event 1 602 and potential event 2 606, but proximity messages for contact C 622 are only received during active interaction intervals during the event interval that corresponds to potential event 1 602. In this case, the interaction intervals are 1 minute long, and the event interval corresponds to 60 interaction intervals. Using equation (1) the event score for potential event 1 602 can be calculated as:

$$S = \frac{{J}_{0} + {J}_{1} + {J}_{2}}{E} = \frac{60 + 20 + 5}{60} = 1.42$$

Where J₀ corresponds to contact A 610, J₁ corresponds to contact B 614, and J₂ corresponds to contact C 622. The event score for potential event 2 604 can be calculated as:

$$S = \frac{{J}_{0} + {J}_{1} + {J}_{2}}{E} = \frac{15 + 15 + 0}{60} = 0.5$$

Where J₀ corresponds to contact A 610, J₁ corresponds to contact B 614, and J₂ corresponds to contact C 622.

An event scores can be stored for a period of time, and, for example, an event score can be persisted for 28 days. However, other time periods are contemplated, and an event score can be stored for 1 week, 2 weeks, 3 weeks, 4 weeks, 5 weeks, 6 weeks, 8 weeks, 9 weeks, 10 weeks, 10 weeks, 11 weeks, or 12 weeks. The event score can be stored with a unique identifier for the event, a start time for the event interval, an end time for an event interval, an event score, a frequency score, a recency score, and a significance score.

### C. Additional Scores

The event score can be augmented with additional score types to identify different types of events. These scores can include recency scores, frequency scores, significance scores, or density scores. An event score can determine whether an electronic device was around multiple contacts, however, the event score alone may not be able to identify significant events comprising interactions with a small number of contacts.

### 1. Density Score

A density score records the total number of devices that transmitted proximity messages to an electronic device during a event interval. The density score calculation is similar to the event score calculation, but while an event score is calculated from proximity messages generated by contacts, the density score is calculated using all devices for which proximity messages were received (e.g., transmitting devices). The density score can be calculated using the following formula:

$$D = \frac{{d}_{0} + {d}_{1} + … + {d}_{n - 1}}{E} \qquad ( 2 )$$

Where D is the density score for an event interval, E is the length of the event interval (e.g., in interaction intervals; 12 for a 60 minute event interval with 5 minute interaction intervals), d is the number of active interaction intervals for a transmitting device, and n is the number of transmitting devices.

### 2. Recency Score

An interaction with one or two contacts may be significant, but the significance can depend on how recently an electronic device's user and a contact interact. For instance, breakfast with a roommate may not be significant, but coffee with a friend from out of town may be significant. A recency score can be used to differentiate between routine interactions and potentially significant meetings.

The recency score can be a value from 0 to 1 that is calculated at the end of each day. A lower recency score can mean that the contact is met more recently, and a higher recency score can mean that the contact was met less recently. The recency score can be calculated from a binary daily score. If the contact was met during the day, the daily score can be set to zero. If the contact was not met during the day, the daily score can be set to 1. In some embodiments, the recency score can be a rolling average of scores calculated using the recency scores for one or more days preceding the current day and the daily score. For example, a recency score can be calculated as an average of the daily score and the recency score for the preceding day. The recency score can be calculated using the following equation:

$${R}_{1} = \frac{{R}_{0} + D}{2} \qquad ( 3 )$$

Where R is the recency score, R₀ is the recency score for the preceding day, and Dis the daily score. D may always be either 0 or 1 based on whether an interaction occurred during the current day, but R₀ can be any value between 0 and 1. For example, if R₀ is 0.5, D is 1 then R₁ can be 0.75. On the next day R₀ is 0.75, D is 0, and R₁ can be 0.375. The recency scores can be sorted into buckets with [0, 0.33) corresponding to a low bucket [0.33, 0.66] corresponding to a medium bucket, and (0.66, 1] corresponding to a high bucket.

### 3. Frequency Score

The frequency score can correspond to the frequency of interactions between an electronic device and a contact. A frequency count can be the number of hours in a day that an electronic device interacts (e.g., receives proximity messages from) a contact. A running mean of the be calculated for each contact using the following formula:

$${M}_{1} = \frac{{M}_{0} + F}{2} \qquad ( 4 )$$

Where M₁ is the current day's running mean, M₀ is the previous days running mean, and F can be the frequency score for the current day. A running mean of squares the be calculated for each contact using the following formula:

$${S}_{1} = \frac{{S}_{0} + {F}^{2}}{2} \qquad ( 5 )$$

Where S₁ is the current day's running mean of squares, S₀ is the previous days running mean of squares, and F is the frequency count for the current day. The persisted mean and the mean of squares that is used to calculate a z-score using the following formula:

$$Z = \frac{F - {M}_{1}}{{S}_{1}} \qquad ( 6 )$$

Where z is the z score, F is the frequency score, M₁ is the current days running mean, and S₁ is the current days running mean of squares. A sigmoid function can be used to map the z score to a value between [0, 1] to get the frequency score. Before the current day's frequency score is calculated, the previous day's frequency score can be used as a temporary frequency score. The temporary frequency score can be used in any calculation or logic that would use a frequency score. A score that converges to 0.5 (e.g., converges to a value within [0.4,0.6]) suggests that the electronic device encounters this device at the same frequency as during other time periods. A score that converges to 0 (e.g., converges to a value within [0, 0.4)) indicates that the user is meeting the contact less frequently than during previous time periods. A score that converges to 1 (e.g., converges to a value within (0.6, 1]) indicates that the electronic device is encountering the contact more frequently than during previous time periods.

### 4. Significance Score

The significance score represents the number of communications between an electronic device and a contact. The significance score can be a time decayed count of these communications where the score is increased once for each communication. A communication can be a text message, an email, a phone call, or a message that is sent through an application. The significance score can be increased for a set period of time in response to a communication. For instance, a text message can cause the score to increase by 1 for a two-day time period after which the score will be decreased by 1. Different communication types may cause the score to increase for different time periods. For example, a text messages may cause the significance score to increase for 12 hours and a phone call between the electronic device and the contact may cause the score to increase for 2 days.

### D. Score Use Cases

Scores, including event scores, recency scores, frequency scores, and significance scores, can be used detect types of interactions that may be suitable as journaling prompts. For example, an event score, by itself, can be used to determine that an electronic device was around a relatively large number of the device's contacts. Such events could include a party, activity, or outing with several friends. Because the event score for such events is high, the additional scores may not be necessary to identify an event such as a party.

The event score and recency score can be used to identify a one-on-one interaction with a close friend. The event score by itself may not be enough to indicate that a significant event has occurred because only one contact is present during an event interval. However, a high frequency score (e.g., a score between (0.6, 1]) can indicate that the contact is a someone that the electronic device's user is seeing more frequently than usual. Accordingly, the interaction can be classified as an interaction with a contact was met more frequently than usual.

The event score, frequency score, and significance score can be used to determine that an electronic device's user met a close friend in person after frequently chatting online. The event score can indicate that the user met a single contact, a high recency score (e.g., recency score of 1) can indicate that the user and contact do not meet frequently, and a high significance score can indicate that the user and contact communicate frequently through their devices.

Similarly, the event score, frequency score, and significance score can indicate that the electronic device's user met a mix of close friends and acquaintances. The event score can indicate that multiple contacts were encountered during an event interval. The frequency score for at least some of the contacts can indicate that the contact is being encountered more frequently than normal, and the significance score for at least some of the contacts can indicate that the electronic device user and the contact frequently interact online. Accordingly, some contacts are acquaintances who are not someone that the user meets frequently, but some of the contacts are in regular communication with the user.

### E. Interaction Events

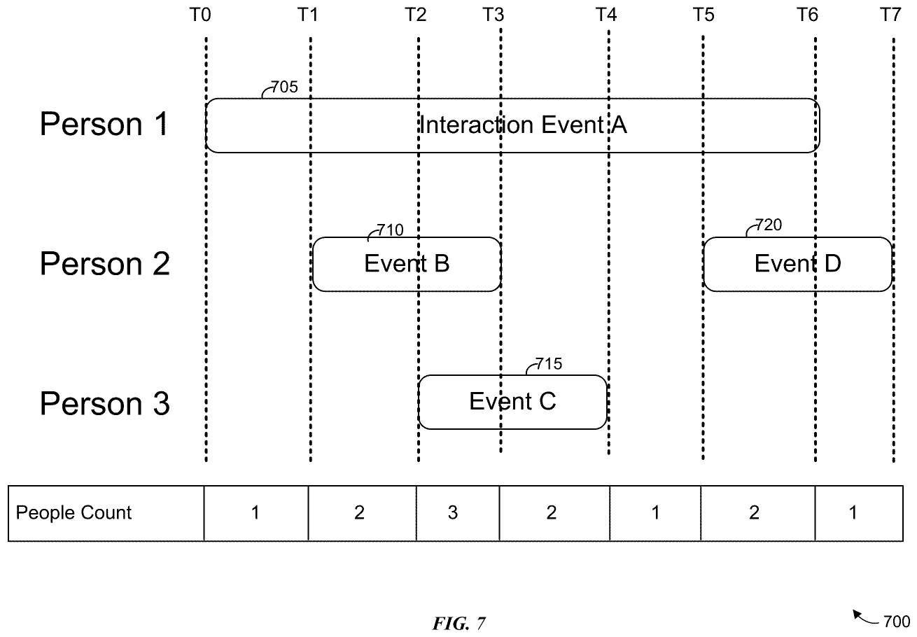

FIG. 7 shows a simplified diagram 700 of an interaction event according to at least one embodiment. Diagram 700 shows time periods where a primary electronic device exchanged proximity messages with electronic devices corresponding to three different individuals. Interaction event A 705 corresponds to an interaction event with a first person's related electronic device. This interaction event is determined to be an interaction event because of an event score that can be calculated based on the length of the interaction (e.g., from T0 to T6) and the number of time periods within the interaction where additional electronic devices were present (e.g., T1-T4, T5-T6). Because of the length and the number of individuals involved, the event score for interaction event A 705 may be relatively high and can exceed an event threshold and be calculated as an interaction event by the primary electronic device.

In contrast, the interaction events with the other two individuals are not determined to be interaction events because the relatively short duration of event B 710, event C 715, and event D 720. The encounter with person 3, shown as event C 715, occurs over a short time period from T2-T4 and the length of the encounter may lead to an event score that does not exceed the event threshold and therefore event C is not categorized as an interaction event. In addition, while the total time of the interaction between the primary electronic device and the related electronic device for person 2 may be relatively long (e.g., T1-T3, T5-T7) these time periods are separated by a gap from T3-T4 and can be considered as separate events with separate event scores that each may not exceed the event threshold even if the events, if combined, may have had an event score that exceeds the event threshold.

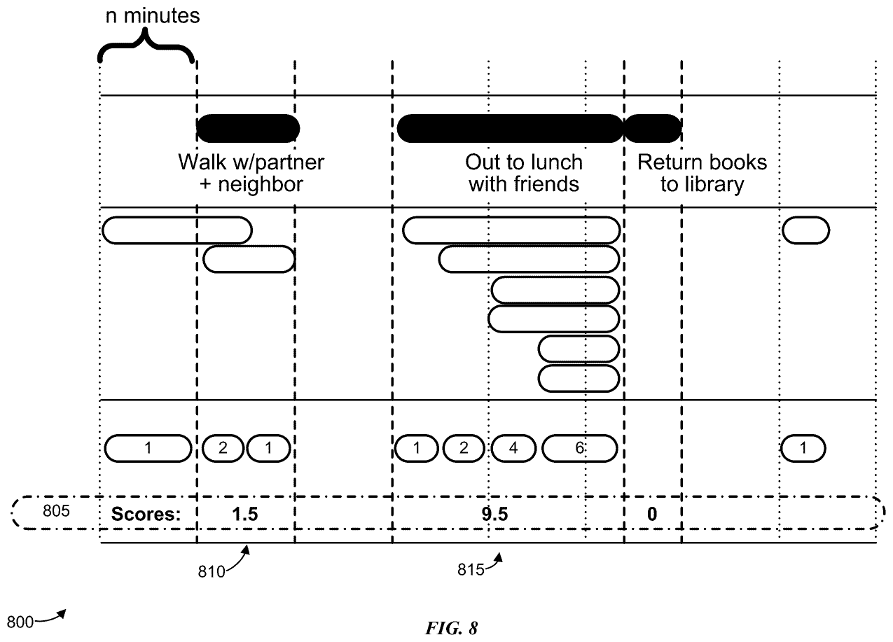

FIG. 8 shows a simplified diagram of event score calculation according to at least one embodiment. In some embodiments, the event scores, shown in row 805, can be influenced by the relationships between the person controlling the primary electronic device and the related electronic devices, in addition to other characteristics. For example, the other characteristics can include a frequency score that tracks how frequently the electronic devices exchange proximity messages, an interaction score that shows how often the two electronic devices interact (e.g., exchange text messages, telephone calls, emails, video calls, etc.), and an event score from past time periods. These characteristics can be stored for different amounts of time with, for example, an interaction score persisting for 28 days while an event score decays to zero over a weeklong period.

The relationship and frequency score for related electronic can be used to weight the event score for a time period. For example, at time period 810, there are two related devices in the time period, but the event score is 1.5. The relatively low event score may be because the two related devices for this time period include a related electronic device with a “partner” relationship type and a high frequency score, and a neighbor's related electronic device with a high frequency score. The relationship type and the frequency scores for these devices may mean that the event scores for these devices are not weighted highly because they are frequently encountered and therefore the walk with the neighbor and partner may not be a meaningful interaction.

In contrast, during time period 815, the primary electronic device encounters related electronic devices with a “friend” relationship type and a low frequency score. While there are more related devices in this time period (e.g., six vs. two in time period 810), the event score would be 4.5 if the related deices in 815 were weighted equally to the related devices in 810. Instead, the event score for the time period 815 is 10.5 because of the number of devices during the time period, the relationship type for the devices (e.g., “friend”), and the different frequency scores between the two time periods. Accordingly, time period 810 may be categorized as an encounter while time period 815 may be categorized as an interaction event.

### F. Detecting Interaction Events

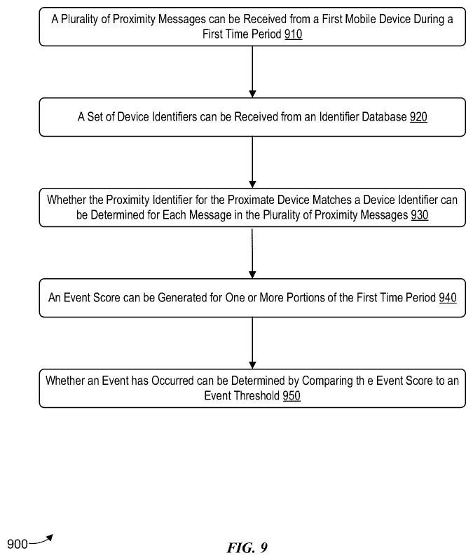

FIG. 9 is a simplified flowchart of a technique for determining whether an interaction event has occurred according to at least one embodiment. In some implementations, one or more method blocks of FIG. 9 may be performed by an electronic device (primary electronic devices 105, 205, 505, electronic devices 115, 120, 220, 225, 230, 235, 240, 245, 250, architecture 500, electronic device 1000). In some implementations, one or more method blocks of FIG. 9 may be performed by another device or a group of devices separate from or including the electronic device.

Additionally, or alternatively, one or more method blocks of FIG. 9 may be performed by one or more components of an electronic device (e.g., primary electronic devices 105, 205, 505, electronic devices 115, 120, 220, 225, 230, 235, 240, 245, 250, architecture 500, electronic device 1000), such as BLE chip 305, SOC 310, AOP 520, memory 525, processor 530, wireless circuitry 1008, processor 1018, etc..

Turning to method 900 in greater detail, at block 910, a plurality of proximity messages can be received during a first time period at a first mobile device (e.g., primary electronic devices 105, 205, 505, electronic devices 115, 120, 220, 225, 230, 235, 240, 245, 250, architecture 500, electronic device 1000). The proximity messages can be received via a wireless personal area network (e.g., at BLE chip 305). Each proximity message can comprise a proximity identifier calculated using a unique identifier for a proximate mobile device that transmitted the proximity message. The proximity identifier can be calculated by signing the unique identifier for the proximate electronic device with a private key. The proximate electronic device can be a related electronic device. The wireless personal area network can be a Bluetooth network and the proximity message can be a Bluetooth Low Energy (BLE) message received at BLE chip 305.

At block 920, a set of device identifiers can be retrieved from an identifier database. The device identifiers can correspond to a set of mobile devices in a contact list for the first mobile device. The contact list can be a list of phone numbers, email addresses, or other contact information that the first mobile device uses to communicate with other devices. In some embodiments, the contact list can be a favorites list or a group of electronic devices that have communicated with the first electronic device via a cellular network during a time period.

At block 930, whether the proximity identifier of the proximate mobile device matches a device identifier for a set of mobile devices can be determined for each message in the plurality of proximity messages. Whether the proximity identifier matches can be determined by decrypting the proximity identifier using a public key retrieved from the identifier database where a public key is retrieved for each mobile device in the set of mobile devices from 920.

At block 940, an event score can be generated for one or more portions of the first time period. The event score can be calculated based on the matching proximity messages from 930, the plurality of proximity messages received during the first time period, the matching proximity messages that were received from the proximate electronic device during the first time period, and a preceding event score that corresponds to a preceding time period. The event score can comprise a probability that an event has occurred between the first electronic device and one or more proximate electronic devices.

At block 950, whether an event has occurred during the time period can be determined by comparing the event score to an event threshold. The event threshold can be a minimum event score where an interaction event is considered to have occurred if the event score is above a threshold. In some embodiments, the event threshold is a maximum event score and an interaction event is considered to have occurred if the event score is below the event threshold. In some embodiments, the event threshold is a first event threshold and a second event threshold and an interaction event is considered to have occurred if the event score is between the first event threshold and the second event threshold.

### IV. Example Devices

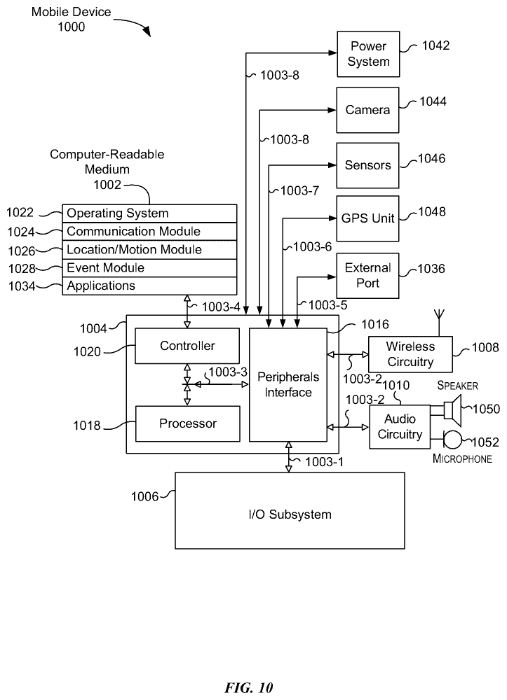

FIG. 10 is a block diagram of an example electronic device 1000 according to at least one embodiment. Device 1000 generally includes computer-readable medium 1002, a processing system 1004, an Input/Output (I/O) subsystem 1006, wireless circuitry 1008, and audio circuitry 1010 including speaker 1012 and microphone 1014. These components may be coupled by one or more communication buses or signal lines 1003. Device 1000 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 10 is only one example of an architecture for device 1000, and that device 1000 can have more or fewer components than shown, or a different configuration of components. The various components shown in FIG. 10 can be implemented in hardware, software, or a combination of both hardware and software, including one or more signal processing and/or application specific integrated circuits.

Wireless circuitry 1008 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1008 can use various protocols, e.g., as described herein. In various embodiments, wireless circuitry 1008 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 602.11a, IEEE 602.11b, IEEE 602.11g and/or IEEE 602.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1008 is coupled to processing system 1004 via peripherals interface 1016. Peripherals interface 1016 can include conventional components for establishing and maintaining communication between peripherals and processing system 1004. Voice and data information received by wireless circuitry 1008 (e.g., in speech recognition or voice command applications) is sent to one or more processors 1018 via peripherals interface 1016. One or more processors 1018 are configurable to process various data formats for one or more application programs 1034 stored on medium 1002.

Peripherals interface 1016 couple the input and output peripherals of device 1000 to the one or more processors 1018 and computer-readable medium 1002. One or more processors 1018 communicate with computer-readable medium 1002 via a controller 1020. Computer-readable medium 1002 can be any device or medium that can store code and/or data for use by one or more processors 1018. Computer-readable medium 1002 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 1016, one or more processors 1018, and controller 1020 can be implemented on a single chip, such as processing system 1004. In some other embodiments, they can be implemented on separate chips.

Processor(s) 1018 can include hardware and/or software elements that perform one or more processing functions, such as mathematical operations, logical operations, data manipulation operations, data transfer operations, controlling the reception of user input, controlling output of information to users, or the like. Processor(s) 1018 can be embodied as one or more hardware processors, microprocessors, microcontrollers, field programmable gate arrays (FPGAs), application-specified integrated circuits (ASICs), or the like.

Device 1000 also includes a power system 1042 for powering the various hardware components. Power system 1042 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1000 includes a camera 1044. In some embodiments, device 1000 includes sensors 1046. Sensors can include accelerometers, compass, gyrometer, pressure sensors, audio sensors, light sensors, barometers, and the like. Sensors 1046 can be used to sense location aspects, such as auditory or light signatures of a location.

In some embodiments, device 1000 can include a GPS receiver, sometimes referred to as a GPS unit 1048. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1018 run various software components stored in medium 1002 to perform various functions for device 1000. In some embodiments, the software components include an operating system 1022, a communication module 1024 (or set of instructions), a location module 1026 (or set of instructions), an event module 1028 that is used as part of event detection described herein, and other application programs 1034 (or set of instructions).

Operating system 1022 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1024 facilitates communication with other devices over one or more external ports 1036 or via wireless circuitry 1008 and includes various software components for handling data received from wireless circuitry 1008 and/or external port 1036. External port 1036 (e.g., universal serial bus (USB), FireWire, Lightning connector, 60-pin connector, etc.) is adapted for coupling directly to other devices or indirectly over a network (e.g., the Internet, wireless local area network (LAN), etc.).

Location/motion module 1026 can assist in determining the current position (e.g., coordinates or other geographic location identifiers) and motion of device 1000. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1026 receives data from GPS unit 1048 and analyzes the signals to determine the current position of the mobile device. In some embodiments, location/motion module 1026 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1008 and is passed to location/motion module 1026. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1000 based on the position coordinates of the corresponding transmitters. Regardless of the specific location technology used, location/motion module 1026 receives information from which a location fix can be derived, interprets that information, and returns location information, such as geographic coordinates, latitude/longitude, or other location fix data

Ranging module 1028 can send/receive ranging messages to/from an antenna, e.g., connected to wireless circuitry 1008. The messages can be used for various purposes, e.g., to identify a sending antenna of a device, determine timestamps of messages to determine a distance of electronic device 1000 from another device. Ranging module 1028 can exist on various processors of the device, e.g., an always-on processor (AOP), a UWB chip, and/or an application processor. For example, parts of ranging module 1028 can determine a distance on an AOP, and another part of the ranging module can interact with a sharing module, e.g., to display a position of the other device on a screen in order for a user to select the other device to share a data item. Ranging module 1028 can also interact with a reminder module that can provide an alert based on a distance from another mobile device.

The one or more applications 1034 on device 1000 can include any applications installed on the device 1000, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1006 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1006 can include a display and user input devices such as a keyboard, mouse, and/or trackpad. In some embodiments, I/O subsystem 1006 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1002) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1006 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1000 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including proximity messages and data from which the proximity message is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine a dwell spot using distance measurements that track a user through their daily routine. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method implemented by an electronic device having a wireless short-range communication circuit and a system on a chip (SOC), the SOC including a coprocessor, a memory, and a processor, the method comprising:
receiving, from one or more other devices, proximity messages at the wireless short-range communication circuit;
forwarding, via a power management bus, the proximity messages to the coprocessor of the SOC, while the processor is in a low power mode;
processing the proximity messages by the coprocessor to obtain processed proximity messages;
storing the processed proximity message in a proximity buffer in the memory of the SOC;
determining whether a triggering event has occurred;
responsive to a triggering event, waking the processor from the low power mode; and
analyzing the processed proximity messages using the processor.

2. The method of claim 1, wherein the processing comprises deduplicating the proximity messages.

3. The method of claim 2, wherein deduplicating the messages comprises:
identifying a first byte pattern in the proximity messages;
storing the first byte pattern to the memory of the SOC;
locating one or more additional byte patterns that match the first byte pattern; and
replacing the one or more additional byte patterns with a reference to the stored first byte pattern.

4. The method of claim 1, wherein the proximity message comprises a unique identifier and a signature that is generated with a private key corresponding to a second electronic device.

5. The method of claim 4, wherein generating the signature comprises:
calculating a signature value using the unique identifier and the private key; and
appending the signature to the unique identifier to produce the proximity message.

6. The method of claim 5, wherein processing the proximity messages comprises verifying the signature using a public key corresponding to the private key.

7. The method of claim 1, wherein the triggering event occurs at an expiration of a timer.

8. The method of claim 1, wherein the trigger event occurs when an amount of utilized space in the memory of the SOC exceeds a memory threshold.

9. The method of claim 1, wherein the receiving further comprises:
identifying one or more messages with a signal strength below a signal threshold; and
discarding the identified one or more messages.

10. The method of claim 1, wherein the processing further comprises:
identifying one or more messages with a signal strength below a signal threshold; and
discarding the identified one or more messages.

11. A method implemented by a first electronic device, the method comprising:
receiving a plurality of proximity messages during a first time period, the proximity messages being received via a wireless personal area network, where each proximity message comprises a proximity identifier calculated using a unique identifier for a proximate electronic device that transmitted the proximity message;
retrieving a set of device identifiers from an identifier database, the set of device identifiers corresponding to a set of electronic devices in a contact list for the first electronic device;
for each message in the plurality of proximity messages:
determining whether the proximity identifier of the proximate electronic device matches a device identifier of the set of electronic devices, thereby determining matching proximity messages;
generating an event score for one or more portions of the first time period based on the matching proximity messages, the event score comprising a probability that an event has occurred between the first electronic device and one or more proximate electronic devices; and
determining whether an event has occurred during the time period by comparing the event score to an event threshold.

12. The method of claim 11, wherein generating the event score further comprises:
retrieving a preceding event score corresponding to a second time period that preceded the first time period; and
generating the event score using at least one of the plurality of proximity messages received during the first time period, the matching proximity messages that were received from the proximate electronic device during the first time period, and the preceding event score.

13. The method of claim 11, wherein generating the event score further comprises:
dividing the first time period into a plurality of second time periods;
for each contact in the contact list for the electronic device:
identifying any time periods in the plurality of time periods where a matching proximity message was received thereby identifying a number of matching time periods; and
dividing the number of matching time periods by a number of time periods in the plurality of second time periods thereby generating an event score for the contact; and
summing the event scores for each contact in the contact list to generate an event score for first time period.

14. The method of claim 13, where the event score is an augmented event score comprising:
the event score determined from the number of proximity messages received from electronic devices in the contact list during the time period;
a density score calculated using a total number of proximity messages received during the time period;
a recency score representing a frequency of interactions between the electronic device and each contact in the contact list;
a frequency score representing a frequency of interactions between the electronic device and each contact in the contact list; and
a significance score representing a frequency of communication between the electronic device and each contact list.

15. The method of claim 11, further comprising:
retrieving one or more preceding event scores that do not match the plurality of proximity messages; and
subtracting a constant from the retrieved one or more preceding event scores.

16. The method of claim 11, wherein the event score is generated based on a number of matching proximity messages that were received during the time period.

17. The method of claim 11, further comprising:
retrieving a private key from the identifier database, the private key corresponding to the first electronic device;
generating a proximity message by signing the device identifier for the first electronic device with the private key; and
transmitting the proximity message.

18. The method of claim 17, wherein the private key corresponding to the first electronic device is changed at a regular interval.

19. The method of claim 11, wherein event threshold is a first event threshold and a second event threshold.

20. The method of claim 19, wherein the event has occurred during the time period if the event score is between the first event threshold and the second event threshold.
